(19) United States
(12) Patent Application Publication
(10) Pub. No.: US 2005/0136312 A1
(43) Pub. Date: Jun. 23, 2005

(54) Compliant fuel cell system

(75) Inventors: Richard Scott Bourgeois, Albany, NY (US); Sauri Gudlavalleti, Albany, NY (US); Shu Ching Quek, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/741,523

(22) Filed: Dec. 22, 2003

(51) Int. Cl. H01M 8/10; H01M 8/00; H01M 2/00; H01M 2/02; H01M 2/08; H01M 2/14

(52) U.S. Cl. 429/32; 429/34; 429/38; 429/39; 429/36; 429/31

(57) ABSTRACT

A fuel cell, comprising a first electrode layer, a second electrode layer and an electrolyte interposed therebetween. The fuel cell further comprises a first electrode interconnect for supporting the first electrode layer. The first electrode interconnect is in intimate contact with the first electrode layer. The fuel cell also comprises a separator plate incorporating a second electrode interconnect for supporting the second electrode layer, which second electrode interconnect is in intimate contact with the second electrode layer, and at least one compliant structure disposed between the first electrode interconnect and the separator plate. In operation, the compliant structure deforms to accommodate motion in the fuel cell.

### BACKGROUND OF THE INVENTION

This invention relates generally to fuel cells and more specifically to compliant fuel cells comprising a complaint structure, which compliant structure deforms to accommodate motion in the fuel cells.

A fuel cell produces electricity by catalyzing fuel and oxidant into ionized atomic hydrogen and oxygen at, respectively, the anode and cathode. The electrons removed from hydrogen in the ionization process at the anode are conducted to the cathode where they ionize the oxygen. In the case of a solid oxide fuel cell, the oxygen ions are conducted through the electrolyte where they combine with ionized hydrogen to form water as a waste product and complete the process. The electrolyte is otherwise impermeable to both fuel and oxidant and merely conducts oxygen ions This series of electrochemical reactions is the sole means of generating electric power within the fuel cell. It is therefore desirable to reduce or eliminate any mixing of the reactants that results in a different combination such as combustion, which combustion does not produce electric power and therefore reduces the efficiency of the fuel cell.

The fuel cells are typically assembled in electrical series in a fuel cell assembly to produce power at useful voltages. To create a fuel cell assembly, an interconnecting member is used to connect the adjacent fuel cells together in electrical series. When the fuel cells are operated at high temperatures, such as between approximately 600° Celsius (C) and 1000° C., the fuel cells are subjected to mechanical and thermal loads that may create strain in the fuel cell assembly and affect the seal separating the oxidant and the fuel paths.

Therefore there is a need to design a fuel cell assembly, which assembly is compliant to thermal or mechanical loads at high operating temperatures. Furthermore to keep the mechanical integrity of the fuel cell assembly, the compliant fuel cell assembly needs to be designed in such a way that any deformation in the fuel cell assembly at high temperatures does not create strain in the fuel cell assembly.

### SUMMARY OF THE INVENTION

Disclosed herein is a fuel cell, comprising a first electrode layer, a second electrode layer and an electrolyte interposed therebetween. The fuel cell further comprises a first electrode interconnect for supporting the first electrode layer. The first electrode interconnect is in intimate contact with the first electrode layer. The fuel cell also comprises a separator plate incorporating a second electrode interconnect for supporting the second electrode layer, which second electrode interconnect is in intimate contact with the second electrode layer, and at least one compliant structure disposed between the first electrode interconnect and the separator plate. In operation, the compliant structure deforms to accommodate motion in the fuel cell.

In another aspect, a fuel cell assembly comprising a plurality of fuel cells is disclosed. The fuel cell comprises a first electrode layer, a second electrode layer and an electrolyte interposed therebetween. The fuel cell further comprises a first electrode interconnect for supporting the first electrode layer, which first electrode interconnect is in intimate contact with the first electrode layer, and a separator plate incorporating a second electrode interconnect for supporting the second electrode layer. The second electrode interconnect is in intimate contact with the second electrode layer. At least one compliant structure is disposed between the first electrode interconnect and the separator plate. The compliant structure deforms to accommodate motion in said fuel cell assembly.

In yet another aspect, a fuel cell assembly comprising a plurality of fuel cells is disclosed. The fuel cell comprises an anode, a cathode and an electrolyte interposed therebetween. The fuel cell further comprises an anode interconnect for supporting an anode layer. The anode interconnect is in intimate contact with the anode layer. The fuel cell also comprises a cathode interconnect for supporting a cathode layer, which cathode interconnect is in intimate contact with the cathode layer. A compliant system is disposed between the anode interconnect and the cathode interconnect. The compliant system comprises a separator plate having at least two surfaces, which separator plate is configured to have a compliant structure on the two surfaces. The compliant structure deforms to accommodate motion in said fuel cell assembly.

### DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a perspective view of an exemplary compliant fuel cell with a compliant structure disposed between an anode interconnect and separator plate;

FIG. 2 illustrates a perspective view of an exemplary compliant fuel cell assembly comprising two fuel cells;

FIG. 2a illustrates the diagrammatical view of a section from the cell 12 of the fuel cell assembly of FIG. 2.

FIGS. 3a, 3b, 3c, 3d, 3e, and 3f illustrate diagrammatical representations of exemplary compliant elements;

FIG. 4 shows a perspective view of an exemplary single compliant element as shown in FIG. 3f in a deflected form;

FIG. 5 shows a diagrammatical view of an exemplary single compliant element as shown in FIG. 3a with stiffener; and

FIG. 6 illustrates a diagrammatical view of a fuel cell assembly with a compliant structure disposed on either side of a separator plate.

### DETAILED DESCRIPTION OF THE INVENTION

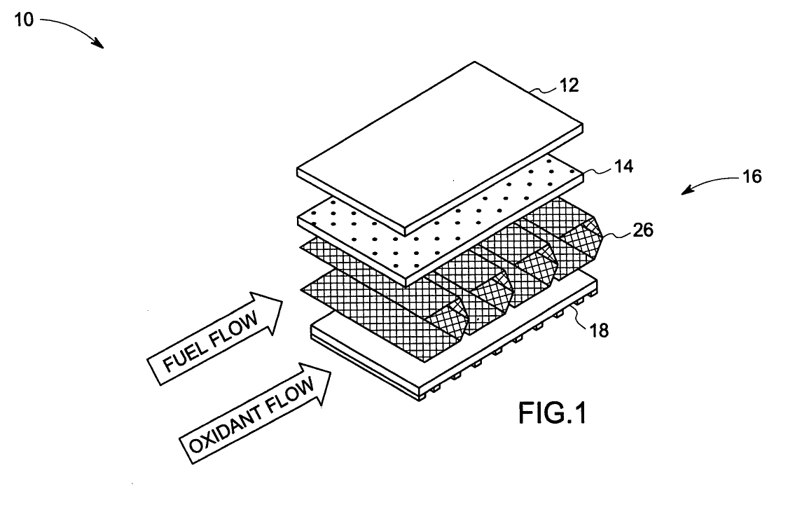

Fuel cells, such as solid oxide fuel cells, have demonstrated a potential for high efficiency and low pollution in power generation. A fuel cell is an energy conversion device that produces electricity, by electrochemically combining a fuel and an oxidant across an ionic conducting layer. Fuel cells may have planar or tubular configurations. Fuel cells may be stacked together either in series or in parallel to construct the fuel cell architecture, capable of producing a resultant electrical energy output. In an exemplary embodiment as illustrated in FIG. 1, fuel cell 10 comprises a cell 12 comprising a first electrode, a second electrode and an electrolyte interposed therebetween. The fuel cell 10 further comprises a first electrode interconnect 14, a separator plate 18, which separator plate is configured to have a second electrode interconnect incorporated, and a compliant structure 16 disposed between the first electrode interconnect 14 and the separator plate 18. In operation the compliant structure 16 is configured to deform to accommodate out of plane motion in the fuel cell 10.

In the exemplary fuel cell as described in FIG. 1 the first electrode is an anode and the second electrode is a cathode. Accordingly the first electrode interconnect 14 is an anode interconnect and the separator plate 18 is configured to have a cathode interconnect incorporated in the separator plate 18. The compliant structure 16 is disposed between the anode interconnect 14 and the separator plate 18. In another embodiment, in a reverse configuration, the first electrode is cathode and the second electrode is anode. Accordingly in this embodiment, the first electrode interconnect is a cathode interconnect and the separator plate is configured to have an anode interconnect incorporated in the separator plate. For the purpose of describing FIGS. 1-6, element 14 is described as the anode interconnect and element 18 is described as the separator plate with cathode interconnect incorporated in the separator plate 18. It may be noted that all the description of the individual elements in the following sections will be applicable for both the embodiments described above.

In the exemplary fuel cell 10, such as the solid oxide fuel cell (SOFC), oxygen ions (O²⁻) generated at the cathode are transported across the electrolyte interposed between the anode and the cathode. The fuel, for example natural gas, is fed to the anode. The fuel at the anode reacts with oxygen ions (O²⁻) transported to the anode across the electrolyte. The oxygen ions (O²⁻) are de-ionized to release electrons to an external electric circuit (not shown). The electron flow thus produces direct current electricity across the external electric circuit.

In the exemplary embodiment as shown in FIG. 1, the cell 12 comprises a single fuel cell having a planar configuration, although multiple such cells may be provided in a single structure, which structure may be referred to as a stack or a collection of cells or an assembly. The cell 12 comprises a cathode layer, an anode layer and an electrolyte layer disposed between the anode layer and the cathode layer. An oxidant flows in the cathode side of the cell 12 and a fuel flows in the anode side of the cell 12.

The main purpose of the anode layer is to provide reaction sites for the electrochemical oxidation of a fuel introduced into the fuel cell. In addition, the anode material should be stable in the fuel-reducing environment, have adequate electronic conductivity, surface area and catalytic activity for the fuel gas reaction at the fuel cell operating conditions and have sufficient porosity to allow gas transport to the reaction sites. The anode can be made of a number of materials having these properties, including but not limited to, metal, Ni, Ni Alloy, Ag, Cu, Noble metals, Cobalt, Ruthenium, Ni-YSZ cermet, Cu-YSZ cermet, Ni-Ceria, cermet, ceramics or combinations thereof.

An electrolyte layer is disposed upon the anode layer typically via deposition. The main purpose of the electrolyte layer is to conduct ions between the anode layer and a cathode layer. The electrolyte layer carries ions produced at one electrode to the other electrode to balance the charge from the electron flow and complete the electrical circuit in the fuel cell. Additionally, the electrolyte separates the fuel from the oxidant in the fuel cell. Accordingly, the electrolyte must be stable in both the reducing and oxidizing environments, impermeable to the reacting gases and adequately conductive at the operating conditions. Typically, the electrolyte layer is substantially electronically insulating. The electrolyte layer can be made of a number of materials having these properties, including but not limited to, ZrO2, YSZ, doped ceria, CeO2, Bismuth sesquioxide, pyrochlore oxides, doped zirconates, perovskite oxide materials and combinations thereof.

Electrolyte layer has a thickness such that electrolyte is substantially gas impermeable. The thickness of electrolyte layer is less than 50 microns, preferably in the range between about 0.1 microns thick to about 10 microns, and most preferably in the range between about 1 microns thick to about 5 microns thick.

A cathode layer is disposed upon the electrolyte. The main purpose of cathode layer is to provide reaction sites for the electrochemical reduction of the oxidant. Accordingly, the cathode layer must be stable in the oxidizing environment, have sufficient electronic conductivity, surface area and catalytic activity for the oxidant gas reaction at the fuel cell operating conditions and have sufficient porosity to allow gas transport to the reaction sites. The cathode layer can be made of a number of materials having these properties, including but not limited to, an electrically conductive oxide, perovskite, doped LaMnO3, Sr-doped LaMnO4 (LSM), tin doped Indium Oxide (In2O3), Strontium-doped PrMnO3, LaFeO3—LaCoO3 RuO2-YSZ, La Cobaltite, and combinations thereof.

In a conventional anode-supported fuel cell comprising a cathode, an anode and an electrolyte disposed between the cathode and the anode, the anode is in intimate contact with the anode interconnect and the cathode is in intimate contact with the cathode interconnect. The anode-supported fuel cell is sealed to the fuel manifold by a seal, which seal typically comprises a material such as glass or ceramic tape. In operation, the temperature of the solid oxide fuel cell may be as high as 1000 Deg C. In the heated condition the seal becomes viscous and the thickness of the seal changes. Once the thickness of the seal changes at high temperature, the anode-supported fuel cell is exposed to uneven mechanical stress and also the seal separating the fuel and oxidant becomes less efficient. The compliant fuel cells, disclosed herein, advantageously provide a solution to such problems associated with the conventional anode-supported fuel cells.

Coming back to FIG. 1, an exemplary fuel cell 10 comprises a cell 12, an anode interconnect 14, a separator plate 18, and a compliant structure 16 disposed between the anode interconnect 14 and the separator plate 18. In operation, the compliant structure 16 is configured to deform to accommodate out of plane motion in the fuel cell 10. Advantageously the compliant structure 16 is compliant enough to avoid strains on the cell during assembly when the glass seal becomes viscous and its thickness changes. The compliance structure 16 also limits the reaction forces in the cell due to stack mechanical loads. In some embodiments, the compliant structure deforms elastically in such a way that the deformation is reversible and in some other embodiments, the compliant structure deforms plastically.

The anode interconnect 14 is in intimate contact with the first electrode of the cell 12 which first electrode is anode in FIG. 1. In some embodiments, the anode is bonded to the anode interconnect 14 using a bond paste. The anode interconnect 14 in some embodiments is substantially rectangular or square in shape and is substantially hollow to create a path for the fuel to reach the anode of the cell 12. Substantially hollow is defined herein as having sufficient perforations or opening to distribute the reactant (fuel or oxidant) uniformly. In one embodiment, the anode interconnect 14 is a perforated sheet. The primary function of the anode interconnect 14 is to electrically connect the anode of the cell 12 to the cathode of an adjacent fuel cell (not shown) when a plurality of fuel cells are stacked in one assembly. In an embodiment, wherein the interconnect 14 is a perforated sheet the perforations provides a flow channel for the fuel to reach the anode in the cell 12. The anode interconnect 14 comprises an electrically conductive material including but not limited to, thin-formed metal, stainless steel, cobaltite, ceramic, LaCrO3, CoCr2O4, Inconel 600, Inconel 601, Hastelloy X, and Hastelloy-230 and combinations thereof. The anode interconnect 14 has a thickness in the range between about 0.1 mm to about 5 mm and preferably between about 0.25 mm to about 0.5 mm.

The separator plate 18 electrically connects the anode interconnect 14 of the cell 12 to the opposite electrode interconnect, for example, the cathode interconnect of an adjacent fuel cell (not shown). In some embodiments, the separator plate 18, is substantially rectangular or square in shape. In one embodiment, the separator plate 18 is a solid sheet with a number of channels on the cathode for the oxidant flow. As shown in FIG. 1, the fuel flows through the compliant structure 16 and the oxidant flows through the channels incorporated in the separator plate 18. In some other embodiments, in the reverse configuration, as indicated in: the preceding sections, the oxidant may flow through the compliant structure and the fuel may flow through the channels in the separator plate. The separator plate 18 comprises an electrically conductive material including but not limited to, thin-formed metal, stainless steel, cobaltite, ceramic, LaCrO3, CoCr2O4, Inconel 600, Inconel 601, Hastelloy X, and Hastelloy-230 and combinations thereof. The interconnect 18 has a thickness in the range between about 0.1 mm to about 5 mm and preferably between about 0.25 mm to about 0.5 mm.

The compliant structure 16 as shown in FIG. 1, has several functions such as, elastically deform to accommodate axial motion in the stack, limit the reaction forces on the cell, conduct electricity through the stack, distribute reactant flows, and support the cell against axial stack loads. Advantageously the interconnect structure 16 is compliant enough to avoid strains on the cell during assembly when the glass seal becomes viscous and its thickness changes. The compliant structure 16 also limits the reaction forces in the cell due to stack mechanical loads. In operation, the compliant structure 16 provides good electrical conduction through the stack and continues to do so after long periods at high temperature in either a reducing (anode interconnect) or oxidizing (cathode interconnect) environment. The compliant structure 16 further provides the fuel cell 10 with sufficient support to resist mechanical loads including differential pressure between the two reactant streams, thermal gradients, and imposed sealing loads. Finally, in some embodiments, the compliant structure 16 is designed to exert and maintain a spring force to keep the proper alignment of the cell 12 in operation.

In some embodiments, the compliant structure 16 is physically bonded to either the anode interconnect 14, or to the separator plate 18 or to both the anode interconnect 14 and the separator plate 18. The compliant structure 16 is designed in such a way that even when it is bonded to both the anode interconnect 14 and the separator plate 18, the complaint structure 16 deforms to accommodate a motion in the stack at high temperatures.

In one embodiment, the compliant structure 16 is constructed from folded sheets of porous metal, such as, expanded mesh. As shown in FIG. 1, the mesh is folded into a shape similar to 4 of 6 connected sides of a regular hexagon to construct the complaint structure 16. Such a shape can be compressed in the stack axial direction without motion in the lateral direction. In some embodiments, the compliant structure described above comprises a first surface for attachment to at least one of an anode interconnect, a separator plate and combinations thereof. The compliant structure further comprises a second surface for attachment to at least one of a cathode interconnect, a separator plate and combinations thereof. The compliant structures are made of one or more compliant elements coupled to the first surface and to the second surface to accommodate motion therebetween. One surface of the compliant structure, such as, folded mesh may be bonded (such as by welding or brazing) to the bottom of the anode interconnect 14. The anode interconnect 14, such as, a perforated metal sheet, is in turn bonded to anode of the cell 12. The anode interconnect may be bonded to the anode by an agent such as for example nickel oxide paste, platinum ink, or platinum paste. The cathode interconnect incorporated in the separator plate 18, may be bonded to the cathode by an agent such as for example LSM paste, platinum ink, or platinum paste. The top surface of the mesh may similarly be coated with an agent to bond it with the anode interconnect 14. The compliant structure 16 is placed with the planes of the structure normal to the fuel flow. A typical mesh is constructed from expanded metal with about 0.010″ thick metal members. As the mesh forming the compliant structure 16 comprises mostly open area, it does not significantly impede the flow, and the pattern of wire serves to break up flow patterns and thus distribute the reactants to the fuel cell more efficiently. The anode side compliant structure 16 comprises a material chosen from nickel, stainless steels, and FeCrAlY. Other useful mesh shapes for construction of the compliant structure 16 include cylinders, spirals, diamond shape, rotated “V” shape, and a shape approximating the Greek capital letter sigma (Σ). In addition to expanded mesh, woven mesh, perforated sheet, woven wires, felt or any other sufficiently ductile porous metal sheet may be used. Expanded mesh is readily available and can be advantageously formed into the compliant structures 16 in an industrial process in a cost effective design.

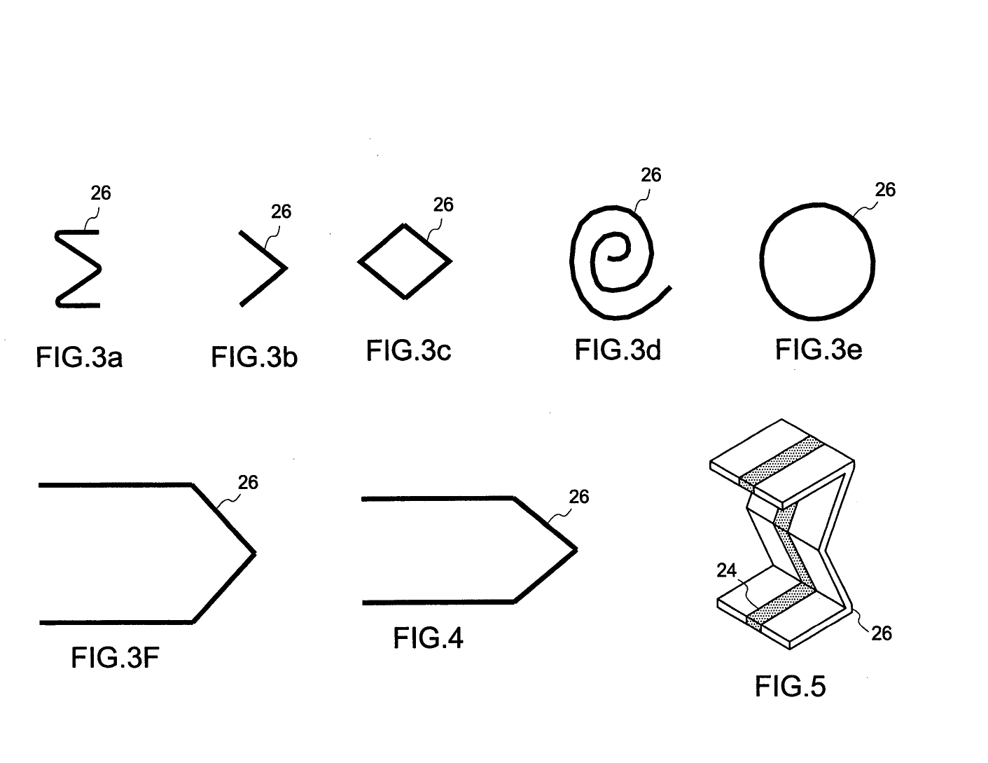

Referring back to FIG. 1, the compliant structure 16 comprises a plurality of compliant elements 26. Some exemplary individual compliant elements 26 are shown in FIG. 3a, 3b, 3c, 3d, 3e, and 3f. FIG. 3a shows an exemplary compliant element 26 in the shape of the Greek letter “sigma”. FIG. 3b shows an exemplary compliant element 26 in a rotated “V” shape. FIG. 3c shows an exemplary compliant element 26 in a diamond shape. FIG. 3d shows an exemplary compliant element 26 in a spiral shape. FIG. 3e shows an exemplary compliant element 26 in a cylinder shape. FIG. 3f shows an exemplary compliant element 26 in a shape, which shape is 4 of 6 connected sides of a regular hexagon. The compliant elements 26, as illustrated in FIGS. 3a to 3f, can be tailored to any desired stiffness. The stiffness calculation is based on a shape that provides vertical compliance. The stiffness of the compliant elements 26 is measured in effective modulus, which modulus ranges from between about 0.00001 E9 N/m\hat{ }2 to about 50 E9 N/m\hat{ }2 and more preferably between about 0.00001 E9 N/m\hat{ }2 to about 0.2 E9 N/m\hat{ }2.

FIG. 4 shows an exemplary compliant element 26 as shown in FIG. 3f in a deflected mode. In operation, due to the mechanical and thermal load of the fuel cell assembly, the compliant elements of the compliant structure 16 deflect elastically such that the effective height of the compliant structure 16 is reduced. But due to the spring force action that is inherently designed in the compliant elements 26, the height of the compliant structure 16 gets adjusted automatically to keep the seal intact.

FIG. 5 shows a single compliant element 26, which compliant element 26 is made in a shape similar to the Greek letter “sigma”. In some embodiments, a compliant element 26 is assembled from sheets of expanded metal mesh with or without stiffeners 24. The stiffness is controlled by the structure of the mesh and the length of the arm within the sigma-shaped structure. These “sigma” compliant elements can be folded for the entire length of the cell or to whatever length necessary depending on the fuel cell shape. The sigma compliant element 26 may be bonded to the bottom of the anode interconnect 14 by means of welding or brazing. Collectively, the sigma-shaped structures will provide the stiffness required to deform in order to accommodate the motion in the stack, limit the reaction forces on the cell, and support the cell against axial stack loads.

As shown in FIG. 5, the sigma shaped compliant element 26 comprises a stiffener 28. The required stiffness is achieved by combining materials with good electrical conductance but poor stiffness with materials that can maintain stiffness at different temperatures.

The fuel cells disclosed herein may be selected from any type of fuel cell including, but not limited to, solid oxide fuel cells, proton exchange membrane fuel cells, molten carbonate fuel cells, phosphoric acid fuel cells, alkaline fuel cells, direct methanol fuel cells, regenerative fuel cells, zinc air fuel cells, and protonic ceramic fuel cells.

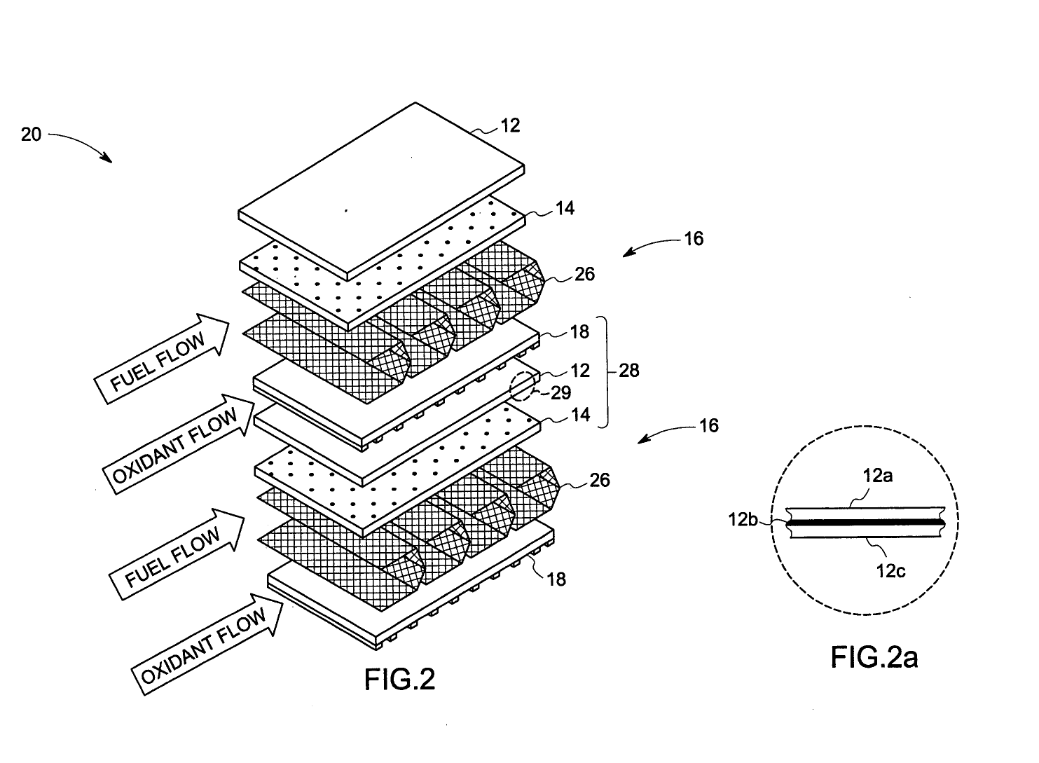

FIG. 2 illustrates an exemplary fuel cell assembly showing a fuel cell assembly 20 comprising two adjacent fuel cells 12. The fuel cell assembly 20 comprises fuel cells 12, anode interconnects 14, separator plates 18 with cathode interconnect incorporated, and compliant structure 16 disposed between the anode interconnect 14 of one fuel cell and the separator plate 18. FIG. 2a shown a cut out of a portion of the cell 29 comprising the cathode 12a, the electrolyte 12b and the anode 12c. In operation, the compliant structure 16 is configured to deform to accommodate out of plane motion in the fuel cell assembly 20. In the fuel cell assembly 20, the cell 12, the anode interconnect 14 and the separator plate 18 forms repeating unit 28. The compliant structure 16 is disposed between each repeating unit 28. Although only two repeating units 28 are shown in the exemplary fuel cell assembly 20, in some embodiments, the fuel cell assembly 20 may comprise a plurality of such repeating units 28. In some embodiments, one compliant structure is followed by more than one repeating units. In practice, in some other embodiments, the repeating unit itself may also comprise the compliant structure 16 wherein the repeating units are placed in a stack to form a fuel cell assembly. The compliant structure 16 forms a path for the fuel flow to the anode through the anode interconnect 14, which anode interconnect 14 is substantially hollow to allow the fuel to come in contact with the anode in the fuel cells 12. In some embodiments, the anode interconnects 14 are perforated sheets and the separator plates 18 are solid sheet which solid sheets are configured to have a number of channels at the cathode side for creating an oxidant passage. In the exemplary embodiment as shown in FIG. 2 the compliant structure 16 comprises a plurality of compliant elements 26, which compliant elements are in the shape similar to 4 of 6 connected sides of a regular hexagon. In operation at high temperature, the compliant structures 16 deforms to adjust the height of the compliant elements 26 so that any thickness change in the seal due to high temperature is adjusted to keep the seal intact. In some embodiments the compliant elements 26 may be designed with stiffeners.

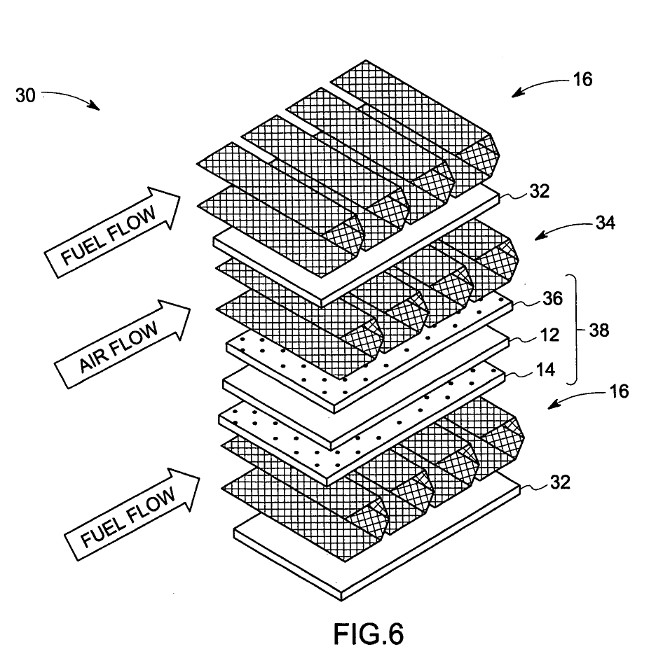

FIG. 6 illustrates an exemplary fuel cell assembly showing a fuel cell assembly 30 comprising compliant structures at both anode and cathode side of cell 12. The fuel cell assembly 30 comprises a cell 12, anode interconnects 14, cathode interconnects 36, and a compliant system comprising two compliant structures 16 and 34 disposed between an anode interconnect 14 and a cathode interconnect 36. The two compliant structures 16 and 34 are in intimate contact with a separator plate 32. The separator plate 32 separates the fuel and the oxidant path so that the fuel and the oxidant do not mix. Compliant structure 16 is in intimate contact with the anode interconnect 14 of the cell 12 and the compliant structure 34 is in intimate contact with the cathode interconnect 36. The cathode interconnect 36 and the anode interconnect 14 are substantially hollow to allow fuel and oxidant to flow to the cathode and the anode of the cell 12 respectively. In operation, the compliant structures 16 and 34 are configured to deform to accommodate out of plane motion in the fuel cell assembly 30. In the fuel cell assembly 30, the cell 12, the anode interconnect 14 and the cathode interconnect 36, forms a repeating unit 38. The compliant structures 16 and 34 on either side of separator plate 32 are disposed between each repeating unit 38. Although only one repeating unit 38 is shown in the exemplary fuel cell assembly 30, in some embodiments, the fuel cell assembly 30 may comprise a plurality of such repeating units 38. In some embodiments, one compliant structure (combination of compliant structures 16 and 34 on either side of the separator plate 32) is followed by more than one repeating units. In practice, in some other embodiments, the repeating unit itself may also comprise the compliant structure (combination of compliant structures 16 and 34 on either side of the separator plate 32) wherein the repeating units are placed in a stack to form a fuel cell assembly. In some embodiments, the anode interconnect 14 and the cathode interconnect 36 are perforated sheets. The topside of the compliant structure 16 is attached to the perforated sheets forming a more consistent flat surface for applying bond paste to adhere it to the cell. The perforated sheet metal when used as anode and cathode interconnects are attached on both sides of the cathode and the anode. This also serves to provide material symmetry to this sub-assembly of compliant structure, cell and perforated sheets. The compliant elements 26 must be placed in such a manner that they do not collide into one another during geometrical changes such as, for example, height changes. The compliant structures 16 and 34 comprise a plurality of compliant elements 26. In some embodiments, operationally at high temperature the compliant structures 16 and 34 deform to adjust the height of the compliant elements 26 so that any thickness change in the seal due to high temperature is adjusted to keep the seal intact. In some embodiments the compliant elements 26 may be designed with stiffeners. One skilled in the art of mechanics and materials can design this structure to deform in different ratios of elastic and plastic deformation depending on applied stresses and temperature range.

The compliant structures 16 and 34 are constructed from folded sheets of porous metal such as expanded mesh as described in the preceding sections. One face of the compliant structure 16 is bonded (such as by welding or brazing) to the bottom of the anode interconnect14, which anode interconnect 14 is in turn bonded by a nickel paste to the anode. One face of the compliant structure 34 is bonded (such as by welding or brazing) to the top of the cathode interconnect 36, which cathode interconnect 36 is in turn bonded by a LSM paste to the cathode. The material for the anode side compliant structure 16 is chosen from nickel, nickel alloys, nichrome, gold, silver, platinum, palladium, ruthenium, rhodium, _{[GGR1]} and FeCrAlY. The material for the cathode side compliant structure 34 is chosen from stainless steels, FeCrAlY,, nichrome, gold, silver, platinum, palladium, ruthenium, and rhodium._{[GGR2]}

In various embodiments discussed above, the number of individual cells in a stack or assembly determines the voltage of the fuel cell system, and ampere rating is determined, in large part, by the surface area of the electrodes.

The compliant fuel cell assemblies, as described in various embodiments herein have several advantages. The compliant structures in the compliant fuel cell assemblies deform in elastic or platic manner to accommodate motion in the stack, limit the reaction forces on the cell, conduct the electricity through the stack, distribute reactant flows, and support the cell against axial stack loads. Advantageously the compliant fuel cell assemblies are compliant enough to avoid strains on the cell when the glass seal becomes viscous and its thickness changes. The compliance structures in the compliant fuel cell assemblies also limit the reaction forces in the cell due to stack mechanical loads. In operation, the compliant structures provide the fuel cells with sufficient support to resist mechanical loads including differential pressure between the two reactant streams, thermal gradients, and imposed sealing loads.

Various embodiments of this invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. Thus, it is intended that the present invention cover all suitable modifications and variations as come within the scope of the appended claims and their equivalents.

1. A fuel cell comprising:
a first electrode layer, a second electrode layer and an electrolyte interposed therebetween;
a first electrode interconnect for supporting said first electrode layer, said first electrode interconnect in intimate contact with said first electrode layer;
a separator plate incorporating a second electrode interconnect for supporting said second electrode layer, said second electrode interconnect in intimate contact with said second electrode layer; and
at least one compliant structure disposed between said first electrode interconnect and said separator plate;
wherein said compliant structure deforms to accommodate motion in said fuel cell.

2. The fuel cell according to claim 1, wherein said first electrode layer is an anode layer and said second electrode layer is a cathode layer.

3. The fuel cell according to claim 1, wherein said first electrode layer is said cathode layer and said second electrode layer is said anode layer.

4. The fuel cell according to claim 2, wherein said first electrode interconnect is an anode interconnect and said second electrode interconnect is a cathode interconnect.

5. The fuel cell according to claim 3, wherein said first electrode interconnect is said cathode interconnect and said second electrode interconnect is said anode interconnect.

6. The fuel cell according to claim 1, wherein said first electrode interconnect is a sheet that is substantially hollow.

7. The fuel cell according to claim 1, wherein said first electrode interconnect is selected from a group consisting of a perforated sheet and a porous sheet.

8. The fuel cell according to claim 1, wherein said first electrode interconnect is bonded directly to said first electrode.

9. The fuel cell according to claim 1, wherein said second electrode interconnect is configured to have channels to supply one of said fuel and oxidant to said second electrode.

10. The fuel cell according to claim 1, wherein said second electrode interconnect is bonded directly to said second electrode.

11. The fuel cell according to claim 1, wherein said electrolyte is substantially impermeable to a gas, and is configured to conduct oxygen ions between said cathode and said anode.

12. The fuel cell according to claim 4, wherein said anode interconnect comprises an electrically and ionically conductive material selected from the group consisting of stainless steel, nickel, nickel alloys, fecralloy, nichrome, gold, silver, platinum, palladium, ruthenium, and rhodium.

13. The fuel cell according to claim 4, wherein said cathode interconnect comprises an electrically and ionically conductive material selected from the group consisting of stainless steel, fecralloy, nichrome, gold, silver, platinum, palladium, ruthenium, and rhodium.

14. The fuel cell according to claim 4, wherein said cathode interconnect comprises stainless steel.

15. The fuel cell according to claim 1, wherein said compliant structure is made of a metal, said metal being electrically conductive.

16. The fuel cell according to claim 1, wherein the shape of said compliant structure is selected from a group consisting of a sigma shaped structure, a diamond shaped structure, and a combination thereof.

17. The fuel cell according to claim 1, wherein said compliant structure is made of a material selected from the group consisting of metallic mesh, woven wire, felt and a combination thereof.

18. The fuel cell according to claim 1, wherein said compliant structure is reinforced with one or more stiffeners.

19. The fuel cell according to claim 1, wherein said compliant structure has an effective modulus of between about 0.00001 E9 N/m\hat{ }2 to about 50 E9 N/m\hat{ }2.

20. The fuel cell according to claim 1, wherein said compliant structure has an effective modulus of between about 0.00001 E9 N/m² to about 0.2 E9 N/m²)

21. The fuel cell according to claim 1, wherein said compliant structure is directly bonded with said first electrode interconnect and said separator plate.

22. The fuel cell according to claim 1, wherein said compliant structure is a passage for one of said oxidant and fuel, said compliant structure configured to supply one of said fuel and oxidant to said first electrode.

23. The fuel cell according to claim 1, wherein said fuel cell is selected from the group consisting of solid oxide fuel cells, proton exchange membrane fuel cells, molten carbonate fuel cells, phosphoric acid fuel cells, alkaline fuel cells, direct methanol fuel cells, regenerative fuel cells, zinc air fuel cells, and protonic ceramic fuel cells.

24. The fuel cell according to claim 1, wherein said fuel cell comprises a solid oxide fuel cell.

25. The fuel cell according to claim 1 having one of a planar and a tubular structure.

26. A fuel cell assembly comprising:
a plurality of fuel cells, said fuel cell comprising a first electrode layer, a second electrode layer and an electrolyte interposed therebetween;
a first electrode interconnect for supporting said first electrode layer, said first electrode interconnect in intimate contact with said first electrode layer;
a separator plate incorporating a second electrode interconnect for supporting said second electrode layer, said second electrode interconnect in intimate contact with said second electrode layer; and
at least one compliant structure disposed between said first electrode interconnect and said separator plate;
wherein said compliant structure deforms to accommodate motion in said fuel cell assembly.

27. The fuel cell according to claim 26, wherein said first electrode layer is an anode layer and said second electrode layer is a cathode layer.

28. The fuel cell according to claim 26, wherein said first electrode layer is said cathode layer and said second electrode layer is said anode layer.

29. The fuel cell according to claim 27, wherein said first electrode interconnect is an anode interconnect and said second electrode interconnect is a cathode interconnect.

30. The fuel cell according to claim 28, wherein said first electrode interconnect is said cathode interconnect and said second electrode interconnect is said anode interconnect.

31. A fuel cell assembly comprising:
a plurality of fuel cells, said fuel cell comprising an anode, a cathode and an electrolyte interposed therebetween;
an anode interconnect for supporting an anode layer, said anode interconnect in intimate contact with said anode layer;
a cathode interconnect for supporting a cathode layer, said cathode interconnect in intimate contact with said cathode layer;
and a compliant system disposed between said anode interconnect and cathode interconnect;
wherein said compliant system comprises a separator plate having at least two surfaces, which separator plate is configured to have a compliant structure on said two surfaces; and said compliant structure deforms to accommodate motion in said fuel cell assembly.

32. The fuel cell assembly according to claim 31, wherein said fuel cell is a solid oxide fuel cell.

33. The fuel cell assembly according to claim 31, wherein said compliant structures are made of a metal, said metal being electrically conductive.

34. The fuel cell assembly according to claim 31, wherein said anode interconnect and said cathode interconnect is independently selected from a group consisting of a perforated sheet and a porous sheet.

35. A compliant structure in a fuel cell comprising a first surface for attachment to at least one of an anode interconnect, a separator plate and combinations thereof;
a second surface for attachment to at least one of a cathode interconnect, a separator plate and combinations thereof; and
a compliant element coupled to said first surface and to said second surface to accommodate motion therebetween.

36. The compliant structure according to claim 35, wherein said compliant structure is made of a metal, said metal being electrically conductive.

37. The compliant structure according to claim 35, wherein the shape of said compliant element is selected from a group consisting of a sigma shaped structure, a diamond shaped structure, and a combination thereof.
